(19) United States
(12) Patent Application Publication
(10) Pub. No.: US 2025/0192917 A1
(43) Pub. Date: Jun. 12, 2025

(54) COMMUNICATION APPARATUS AND METHOD FOR CONNECTED AUTONOMOUS DRIVING

(71) Applicant: DAEBO COMMUNICATION & SYSTEMS CORPORATION, Yongin-si (KR)

(72) Inventors: Kyong Hun JEON, Suwon-si (KR); Byeong-Woo BAE, Yongin-si (KR); Sung-Jin LEE, Yongin-si (KR)

(73) Assignee: DAEBO COMMUNICATION & SYSTEMS CORPORATION, Yongin-si (KR)

(21) Appl. No.: 18/963,751

(22) Filed: Nov. 28, 2024

(30) Foreign Application Priority Data
Dec. 6, 2023 (KR) 10-2023-0175948

(51) Int. Cl. H04L 1/00; H04W 4/40

(52) U.S. Cl. CPC H04L 1/0045; H04L 1/0061; H04W 4/40

(57) ABSTRACT

The present invention discloses a communication apparatus and method for connected autonomous driving. A communication apparatus for connected autonomous driving of the present invention includes an Ethernet communication module that performs communication through an Ethernet communication method, a vehicle-to-everything (V2X) that performs communication through a V2X communication method, a memory, and a processor operatively coupled to the Ethernet communication module, the V2X communication module, and the memory, wherein the processor determines the type of message of data received from the Ethernet communication module or the V2X communication module, and when the type of message is an extension message, decodes an overall package included in the extension message, then attaches request information to the extension message as a unit package according to the overall package, and updates the overall package to transmit encoded data through the Ethernet communication module or the V2X communication module.

### CROSS-REFERENCE TO RELATED APPLICATION

The present application claims priority and the benefit of Korean Patent Application No. 10-2023-0175948, filed on Dec. 6, 2023 in the Korean Intellectual Property Office, the entire disclosure of which is incorporated herein by reference.

### BACKGROUND

### 1. Field of the Invention

The present invention relates to a communication apparatus and method for connected autonomous driving, and more specifically, to a communication apparatus and method for connected autonomous driving, which are capable of securing verification data through an extension message for performance verification when vehicles communicate with each other or the vehicle communicates with a roadside base station for connected autonomous driving in a 5G-new radio-vehicle-to-everything (5G-NR-V2X) environment.

### 2. Discussion of Related Art

An autonomous driving vehicle is a vehicle capable of autonomously driving without manipulation of a driver or passenger, and recently, the development of autonomous driving vehicles has been actively conducted.

An autonomous driving algorithm is generally composed of perception, positioning, determination, and control stages. Perception and positioning algorithms collect information on a surrounding environment using radar and light detection and ranging (LiDAR) sensors that are attached to a vehicle and identify a current position of the vehicle using GPS information. Using the information obtained in this way, a target route and speed of the vehicle are determined in the determination stage. Finally, a stage of applying an input so that an actual vehicle can follow the determined behavior corresponds to the control stage.

According to classification of six automation levels announced by the International Society of Automotive Engineers in 2016, “Level 0” is a stage in which a driver is in charge of all manipulations, and obstacles are perceived and notified using a forward collision warning system, an active blind spot detection sensor, etc., “Level 1” is a stage in which a driving of a driver gets assisted using only one of a lane keeping assist, smart cruise control, etc., “Level 2” is a stage in which both of the above functions are simultaneously supported to provide a higher level of assistance, “Level 3” is a stage in which a vehicle operates in an autonomous driving mode under specific conditions and intervention of the driver is required in emergency situations, “Level 4” is a stage in which an autonomous system is in charge of responding to emergency situations but intervention of a driver is made possible as needed, and “Level 5” is a stage in which full autonomous driving is made possible without a driver.

Currently, in Korea, the commercialization of Level 4 autonomous driving vehicles is targeted by 2027, and Level 4 autonomous driving vehicles have been developed. The final goal of autonomous driving technologies will be “Level 5”, which is the capability of full autonomous driving.

The background technology of the present invention is disclosed in Korean Laid-Open Patent No. 10-2023-0100591 (published on Jul. 5, 2023 and entitled “Autonomous driving system and autonomous driving support method, which easily reflect regional characteristic map”).

### SUMMARY OF THE INVENTION

To support autonomous driving services of Level 4 or higher and improve autonomous driving safety in this manner, communication equipment and application services are being developed to secure real road verification-based performance data of 5G-NR-V2X communication technology that supports the characteristics of ultra-high speeds of 150 Mbps or higher, ultra-low latency of 3 ms or less, and high reliability of 99.99% or higher.

That is, it is necessary to verify whether the communication requirements for full autonomous driving (Level 4 or higher) are satisfied through real-road verification using an on-board unit (OBU) (vehicle terminal) for 5G-NR-V2X communication and a roadside unit (RSU) (roadside base station) and secure verification data through the aforementioned verification.

The present invention according to one aspect is directed to providing a communication apparatus and method for connected autonomous driving, which are capable of securing verification data through an extension message for performance verification when vehicles communicate with each other or the vehicle communicates with a roadside base station for connected autonomous driving in a 5G-NR-V2X environment.

A communication apparatus for connected autonomous driving according to one aspect of the present invention includes an Ethernet communication module that performs communication through an Ethernet communication method, a vehicle-to-everything (V2X) that performs communication through a V2X communication method, a memory, and a processor operatively coupled to the Ethernet communication module, the V2X communication module, and the memory, wherein the processor determines the type of message of data received from the Ethernet communication module or the V2X communication module, and when the type of message is an extension message, decodes an overall package included in the extension message, then attaches request information to the extension message as a unit package according to the overall package, and updates the overall package to transmit encoded data through the Ethernet communication module or the V2X communication module.

The V2X communication method may be a 5G-new-radio-vehicle-to-everything (5G-NR-V2X) communication method.

The request information may be information that is set in or received by the communication apparatus.

The processor may perform a cyclic redundancy check (CRC) test on the overall package while decoding the overall package and calculate a CRC for the overall package while encoding the updated overall package.

A format of the overall package may include a package type field, a length field, an identifier field, a version field, a field for the number of subsequent unit packages, a field for a sum of lengths of the subsequent unit packages, and a CRC field.

A format of the unit package may include a package type field, a length field, a data field, and a CRC field.

A communication method for connected autonomous driving according to another aspect of the present invention includes receiving, by a processor, data from an Ethernet communication module or a vehicle-to-everything (V2X) communication module, determining, by the processor, the type of message of the received data, decoding, by the processor, an overall package included in an extension message when it is determined that the type of message is the extension message, attaching, by the processor, request information to the extension package as a unit package according to the overall package, updating, by the processor, the overall package and then encoding the overall package, and transmitting, by the processor, encoded data through the Ethernet communication module or the V2X communication module.

The V2X communication module may transmit and receive data through a 5G-new-radio-vehicle-to-everything (5G-NR-V2X) communication method.

The request information may be information that is set in or received by the communication apparatus.

The decoding of the overall package may include performing, by the processor, a CRC test on the overall package while decoding the overall package.

The encoding of the overall package may include calculating, by the processor, a CRC for the overall package while encoding the overall package.

A format of the overall package may include a package type field, a length field, an identifier field, a version field, a field for the number of subsequent unit packages, a field for a sum of lengths of the subsequent unit packages, and a CRC field.

A format of the unit package may include a package type field, a length field, a data field, and a CRC field.

### BRIEF DESCRIPTION OF THE DRAWINGS

The following drawings attached to this specification illustrate embodiments of the present invention, and further describe aspects and features of the present invention together with the detailed description of the present invention. Thus, the present invention should not be construed as being limited to the drawings, in which:

FIG. 1 is a block configuration diagram illustrating a communication apparatus for connected autonomous driving according to one embodiment of the present invention;

FIG. 2 is an exemplary view illustrating a structure of an extension message in the communication apparatus for connected autonomous driving according to one embodiment of the present invention; and

FIG. 3 is a flowchart for describing a communication method for connected autonomous driving according to one embodiment of the present invention.

### DETAILED DESCRIPTION OF EXEMPLARY EMBODIMENTS

Hereinafter, a communication apparatus and method for connected autonomous driving according to the present invention will be described with reference to the accompanying drawings.

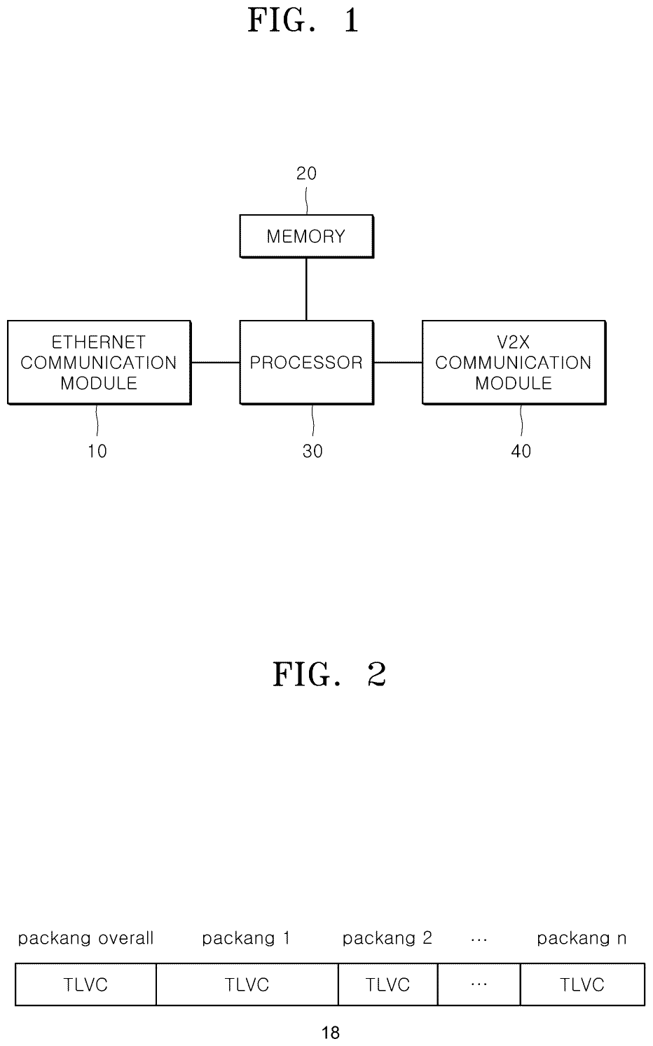

FIG. 1 is a block configuration diagram illustrating a communication apparatus for connected autonomous driving according to one embodiment of the present invention, and FIG. 2 is an exemplary view illustrating a structure of an extension message in the communication apparatus for connected autonomous driving according to one embodiment of the present invention.

As illustrated in FIG. 1, the communication apparatus for connected autonomous driving of the present invention may include an Ethernet communication module 10, a vehicle-to-everything (V2X) communication module 40, a memory 20, and a processor 30.

The Ethernet communication module 10 provides an interface for communication through an Ethernet communication method to transmit and receive data with external equipment.

For example, the external equipment may include an autonomous driving support server or a vehicle control device.

The V2X communication module 40 may provide an interface for communication through a V2X communication method to transmit and receive data with a vehicle terminal (on board unit (OBU)) or a roadside base station (roadside unit (RSU)).

Therefore, the communication apparatus for connected autonomous driving according to the present embodiment may be applied to the vehicle terminal or the roadside base station.

Here, the V2X communication method is a 5G-new-radio-vehicle-to-everything (5G-NR-V2X) communication method and may support the characteristics of ultra-high speed of 150 Mbps or more, ultra-low latency of 3 ms or less, and high reliability of 99.99% or more.

The memory 20 may store an execution program related to the operation of the communication apparatus for connected autonomous driving, and the stored information may be selected by the processor 30 as needed.

That is, various types of data and commands generated during the execution of an operating system (O/S) or an application (program or applet) for driving the communication apparatus for connected autonomous driving are stored in the memory 20. In this case, the memory 20 may be implemented as a nonvolatile memory, a volatile memory, a flash memory, a hard disk drive (HDD), a solid state drive (SSD), etc. In addition, the memory 20 may be accessed, and data may be read/written/modified/deleted/updated by the processor 30.

The processor 30 may be operatively coupled to the Ethernet communication module 10, the V2X communication module 40, and the memory 20 to perform various operations by copying various programs stored in the memory 20 to a random-access memory (RAM) and executing the programs in order to control the overall operation of the communication apparatus for connected autonomous driving.

Here, the processor 30 has been described as including only one central processing unit (CPU), but may be implemented as a plurality of CPUs (or a digital signal processor (DSP), a system on chip (SoC), etc.) when implemented.

In various embodiments, the processor 30 may be implemented as a DSP that processes digital signals, a microprocessor, or a time controller (TCON). However, the processor 30 is not limited thereto, and may include one or more of a CPU, a micro controller unit (MCU), a micro processing unit (MPU), a controller, an application processor (AP), a communication processor (CP), or an ARM processor or may be defined with a corresponding term. In addition, the processor 30 may be implemented as an SOC or a large scale integration (LSI) with a built-in processing algorithm or may be implemented in the form of a field programmable gate array (FPGA).

That is, the processor 30 may be driven by executing an execution program stored in the memory 20 and then determine the type of message included in a payload of data received from the Ethernet communication module 10 or the V2X communication module 40.

In this case, when the type of message is a fixed message, the processor 30 copies the received data as a message and retransmits the message.

However, when the type of the message is an extension message, the processor 30 may decode an overall package Pₒᵥₑᵣₐₗₗ included in the extension message and then attach request information to the extension message as a unit package according to the overall package.

That is, the extension message may be formed of a set of the overall package and an attached unit package Pn as illustrated in FIG. 2.

In this case, a format of the overall package may include a package type field T, a length field L, an identifier field, a version field, a field of the number of subsequent unit packages, a field of the sum of lengths of the subsequent unit packages, and a cyclic redundancy check (CRC) field C.

Therefore, the size of the extension message and the number of unit packages included in the extension message may be known through the overall package, and when a unit package is attached and added to the extension message, only the overall package is updated and the remaining unit packages are not changed.

In this way, in the case of the extension message, since only the overall package is decoded and updated, the processor 30 may perform a CRC test on the overall package while decoding the overall package and calculate the CRC for the overall package while encoding the updated overall package, thereby minimizing a CRC calculation time during the decoding and encoding processes.

In addition, the format of the unit package may include a package type field T, a length field L, a data field V, and a CRC field C.

In this way, the overall package and the unit package may be classified according to the type of package, and according to the type of package, the data field V of the overall package may be classified into an identifier field, a version field, a field for the number of subsequent unit packages, and a field for the sum of lengths of the subsequent unit packages.

When the processor 30 attaches the request information to the extension message as the unit package as described above, the request information may be set by the communication apparatus or included in the received data.

In this case, the request information is state information for performance verification in the 5G-NR-V2X communication environment and may include not only an ID of equipment, hardware and software versions, timestamps, output power, modulation/demodulation states, position information, a communication state, a control state, etc., but also other optional information.

In this way, after attaching the request information to the extension message as the unit package, the processor 30 may update and encode the overall package and then transmit data through the Ethernet communication module 10 or the V2X communication module 40.

As described above, according to the communication apparatus for connected autonomous driving according to the embodiment of the present invention, by securing verification data by defining the extension message as a set of the overall package and the unit package and attaching state information to each device as the unit package for performance verification when vehicles communicate with each other or the vehicle communicates with the roadside base station for connected autonomous driving in the 5G-NR-V2X environment, it is possible to minimize lengths of all data increased by assigning as much data space as needed, thereby minimizing a transmission time, and decode and encode only the overall package, thereby saving a CRC calculation time.

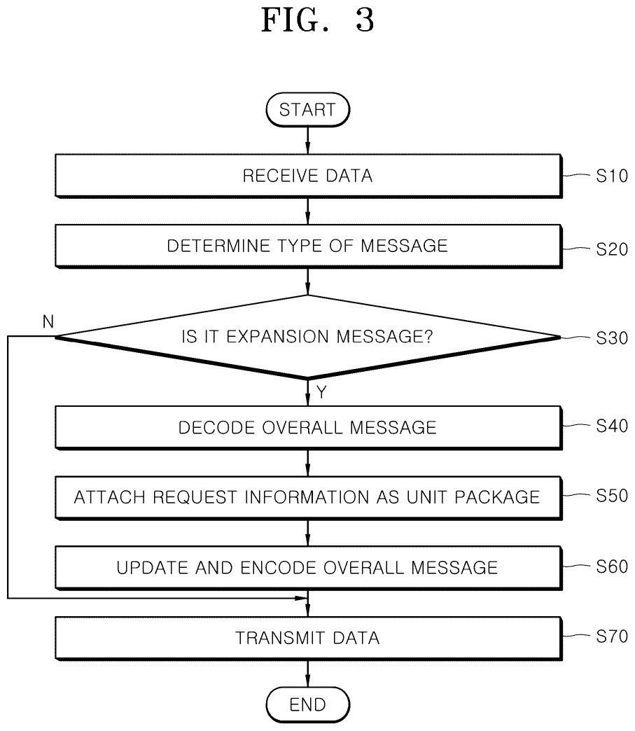

FIG. 3 is a flowchart for describing a communication method for connected autonomous driving according to one embodiment of the present invention.

As illustrated in FIG. 3, in the communication method for connected autonomous driving according to one embodiment of the present invention, first, the processor 30 is driven by executing the execution program stored in the memory 20 and then receives data from the Ethernet communication module 10 or the V2X communication module 40 (S10).

In the present embodiment, the Ethernet communication module 10 may provide an interface for communication through an Ethernet communication method to transmit and receive data with external equipment.

For example, the external equipment may include an autonomous driving support server or a vehicle control device.

In addition, the V2X communication module 40 may provide an interface for communication through a V2X communication method to transmit and receive data with the vehicle terminal (OBU) or a roadside base station (RSU).

The communication apparatus for connected autonomous driving according to the present embodiment may be applied to the vehicle terminal or the roadside base station.

Here, the V2X communication method is a 5G-new-radio-vehicle-to-everything (5G-NR-V2X) communication method and may support the characteristics of ultra-high speed of 150 Mbps or more, ultra-low latency of 3 ms or less, and high reliability of 99.99% or more.

After receiving data in operation S10, the processor 30 determines the type of message of the received data (S20).

Here, the processor 30 may determine the type of message included in a payload of the received data.

In operation S20, whether the type of determined message is an extension message is determined (S30).

When it is determined in operation S30 that the type of message is not an extension message and is a fixed message, the processor 30 copies the message of the received data without any change and retransmits the message (S70).

However, when it is determined that the type of message is an extension message, the processor 30 decodes the overall package Pₒᵥₑᵣₐₗₗ included in the extension message (S40).

Here, the extension message may be formed of the set of the overall package and the attached unit package Pn as illustrated in FIG. 2.

In this case, a format of the overall package may include a package type field T, a length field L, an identifier field, a version field, a field for the number of subsequent unit packages, a field for the sum of lengths of the subsequent unit packages, and a CRC field C.

Therefore, the size of the extension message and the number of unit packages included in the extension message may be known through the overall package, and when a unit package is attached and added to the extension message, only the overall package is updated and the remaining unit packages are not changed.

In this way, when the type of message is an extension message, since only the overall package is decoded and updated, the processor 30 performs a CRC test on the overall package while decoding the overall package.

After decoding the overall package in operation S40, the processor 30 attaches defined request information, such as the version field of the overall package, to the extension message as a unit package (S50).

In this case, the request information may be set in the communication apparatus and included in the received data, is state information for performance verification in the 5G-NR-V2X communication environment, and may include not only ID of equipment, hardware and software versions, timestamps, output power, modulation/demodulation states, position information, a communication state, a control state, etc., but also other optional information.

In addition, the format of the unit package may include a package type field T, a length field L, a data field V, and a CRC field C.

In this way, the overall package and the unit package may be classified according to the type of package, and according to the type of package, the data field V of the overall package may be classified into an identifier field, a version field, a field for the number of subsequent unit packages, and a field for the sum of lengths of the subsequent unit packages.

After attaching the request information to the extension message as a unit package in operation S50, the processor 30 updates and encodes the overall package (S60).

In this case, the processor 30 may calculate the CRC for the overall package while encoding the updated overall package, thereby minimizing the CRC calculation time during the decoding and encoding processes.

After updating and encoding the overall package in operation S60, the processor 30 transmits data through the Ethernet communication module 10 or the V2X communication module 40 (S70).

As described above, according to the communication method for connected autonomous driving according to the embodiment of the present invention, by securing verification data by defining the extension message as a set of the overall package and the unit package and attaching state information to each device as the unit package for performance verification when vehicles communicate with each other or the vehicle communicates with the roadside base station for connected autonomous driving in the 5G-NR-V2X environment, it is possible to minimize lengths of all data increased by assigning as much data space as needed, thereby minimizing a transmission time, and decode and encode only the overall package, thereby saving a CRC calculation time.

According to a communication method for connected autonomous driving according to an aspect of the present invention, by securing verification data by defining an extension message as a set of an overall package and a unit package and attaching state information to each device as the unit package for performance verification when vehicles communicate with each other or the vehicle communicates with a roadside base station for connected autonomous driving in a 5G-NR-V2X environment, it is possible to minimize lengths of all data increased by assigning as much data space as needed, thereby minimizing a transmission time, and it is possible decode and encode only the overall package, thereby saving a CRC calculation time.

What is claimed is:

1. A communication apparatus for connected autonomous driving, comprising:
an Ethernet communication module configured to perform communication through an Ethernet communication method;
a vehicle-to-everything (V2X) configured to perform communication through a V2X communication method;
a memory; and
a processor operatively coupled to the Ethernet communication module, the V2X communication module, and the memory,
wherein the processor determines a type of message of data received from the Ethernet communication module or the V2X communication module, and when the type of message is an extension message, decodes an overall package included in the extension message, then attaches request information to the extension message as a unit package according to the overall package, and updates the overall package to transmit encoded data through the Ethernet communication module or the V2X communication module.

2. The communication apparatus of claim 1, wherein the V2X communication method is a 5G-new-radio-vehicle-to-everything (5G-NR-V2X) communication method.

3. The communication apparatus of claim 1, wherein the request information is information that is set in or received by the communication apparatus.

4. The communication apparatus of claim 1, wherein the processor performs a cyclic redundancy check (CRC) test on the overall package while decoding the overall package and calculates a CRC for the overall package while encoding the updated overall package.

5. The communication apparatus of claim 1, wherein a format of the overall package includes a package type field, a length field, an identifier field, a version field, a field for the number of subsequent unit packages, a field for a sum of lengths of the subsequent unit packages, and a cyclic redundancy check (CRC) field.

6. The communication apparatus of claim 1, wherein a format of the unit package includes a package type field, a length field, a data field, and a cyclic redundancy check (CRC) field.

7. A communication method for connected autonomous driving, comprising:
receiving, by a processor, data from an Ethernet communication module or a vehicle-to-everything (V2X) communication module;
determining, by the processor, a type of message of the received data;
decoding, by the processor, an overall package included in an extension message when it is determined that the type of message is the extension message;
attaching, by the processor, request information to the extension package as a unit package according to the overall package;
updating, by the processor, the overall package and then encoding the overall package; and
transmitting, by the processor, encoded data through the Ethernet communication module or the V2X communication module.

8. The communication method of claim 7, wherein the V2X communication module transmits and receives data through a 5G-new-radio-vehicle-to-everything (5G-NR-V2X) communication method.

9. The communication method of claim 7, wherein the request information is information that is set in or received by a communication apparatus.

10. The communication method of claim 7, wherein the decoding of the overall package includes performing, by the processor, a cyclic redundancy check (CRC) test on the overall package while decoding the overall package.

11. The communication method of claim 7, wherein the encoding of the overall package includes calculating, by the processor, a cyclic redundancy check (CRC) for the overall package while encoding the overall package.

12. The communication method of claim 7, wherein a format of the overall package includes a package type field, a length field, an identifier field, a version field, a field for the number of subsequent unit packages, a field for a sum of lengths of the subsequent unit packages, and a cyclic redundancy check (CRC) field.

13. The communication method of claim 7, wherein a format of the unit package includes a package type field, a length field, a data field, and a cyclic redundancy check (CRC) field.
